(19) United States
(12) Patent Application Publication
(10) Pub. No.: US 2009/0290462 A1
(43) Pub. Date: Nov. 26, 2009

(54) SIGNAL PROCESSING DEVICE FOR OPTICAL DISC, INTEGRATED CIRCUIT, OPTICAL DISC DEVICE, AND OPTIMUM RECORDING FOCUS POSITION DETECTING METHOD

(76) Inventor: Katsumi Morita, Kyoto (JP)

Correspondence Address: MCDERMOTT WILL & EMERY LLP, 600 13TH STREET, NW, WASHINGTON, DC, 20005-3096, US

(21) Appl. No.: 12/307,838

(22) PCT Filed: Jul. 9, 2007
(86) PCT No.: PCT/JP2007/063678

§ 371 Date: Jan. 7, 2009

(30) Foreign Application Priority Data
Jul. 10, 2006 (JP) 2006-188872

(51) Int. Cl. G11B 7/00; G11B 7/12

(52) U.S. Cl. 369/47.53; 369/53.41; G9B/7

(57) ABSTRACT

An optical disc signal processing device includes a focus position determining section, wherein when test recording is performed while changing a focus position through a plurality of positions, the focus position determining section obtains an optimum recording focus position based on recording qualities of regions on the optical disc where the test recording has been performed. The focus position determining section includes: a recording state measuring section for measuring, for each focus position, a recording quality of a region on the optical disc where the test recording has been performed; and a determination section for determining, according to a predetermined criterion, whether laser power during the test recording is suitable for obtaining the optimum recording focus position, based on the recording quality obtained for each focus position by the recording state measuring section. When it is determined by the determination section that the laser power during the test recording is not suitable for obtaining the optimum recording focus position, the optical disc signal processing device controls the optical pickup so that the test recording is performed again with the laser power changed.

### TECHNICAL FIELD

The present invention relates to a focusing technique for an optical disc device and, more particularly, to a technique for adjusting an optimum recording focus position.

### BACKGROUND ART

In recent years, various types of optical discs have been commercialized, and there is a demand for an optical disc device capable of recording and reproducing a large amount of data at a higher speed.

In order to record/reproduce data at a high speed while ensuring a high reliability of the high-speed recording, the focus position needs to be optimally controlled so that the light beam is focused on the recording surface of the optical disc during recording.

Normally, the optimum focus position during recording (optimum recording focus position) is different from the optimum focus position during reproduction. This is because there occurs an offset or chromatic aberration inside the optical pickup or on the electric circuit due to a change in the laser power. Therefore, an optical disc device normally obtains different optimum focus positions separately for recording and for reproduction.

Conventionally, the optimum recording focus position is obtained by performing recording while changing the focus position one after another and then measuring the signal quality of each recorded region of the optical disc to obtain the relationship between the signal quality and the recording focus position, wherein the focus position at which the signal quality is best is used as the optimum focus position for recording.

Patent Documents 1 to 4 each disclose a technique using an approximate equation for easily obtaining the optimum focus position during reproduction.

Patent Document 1: Japanese Laid-Open Patent Publication No. 4-238120

Patent Document 2: Japanese Laid-Open Patent Publication No. 2-246024

Patent Document 3: Japanese Laid-Open Patent Publication No. 11-053744

Patent Document 4: Japanese Laid-Open Patent Publication No. 2002-342963

### DISCLOSURE OF THE INVENTION

### Problems to be Solved by the Invention

However, with the conventional method in which recording is performed while changing the focus position one after another and then measuring the signal quality of each recorded region, wherein the focus position at which the signal quality is best is used as the optimum recording focus position, it is necessary to measure the signal quality about 20 to 30 times, requiring a long time, in order to obtain the optimum recording focus position with a high precision. Therefore, when the optimum recording focus position of an optical disc device before being shipped is obtained in a factory, or the like, by using this method, and if write-once type optical discs such as CD-Rs or DVD-Rs are used in recording, a large number of optical discs will be consumed.

When one attempts, using an optical disc device after being shipped, to obtain the optimum recording focus position by the method as described above by recording on a write-once type optical disc such as a CD-R or a DVD-R, there is no sufficient TEST region of the optical disc and the adjustment cannot be done.

In view of this, another method is to obtain an approximate equation representing the relationship between the signal quality and the focus position, and to obtain, as the optimum recording focus position, the focus position corresponding to the pole of the curve representing the approximate equation. With this method, it is possible to accurately obtain the optimum recording focus position with fewer measurements than with the above conventional method, and to thereby shorten the amount of time and the amount of disc required for obtaining the optimum recording focus position.

However, the present inventor found the following problem with this method using an approximate equation.

First, the power of the laser beam with which the recording surface of the optical disc is irradiated varies from one apparatus to another. This is because of variations in the light transmission efficiency of the optical pickup and those in the nature of the laser device used in the optical pickup. Therefore, the recording laser power of an individual apparatus may be too high or too low. When the recording laser power is too high or too low, the signal quality does not vary substantially in response to a change in the recording focus position, whereby the approximate curve representing the relationship between the signal quality and the focus position will be flat. In such a case, the value representing the focus position corresponding to the pole of the approximate curve will be far apart from the value representing the optimum focus position. The tendency of the approximate curve being flat when the laser power is too high or too low is particularly pronounced when a double-layer disc is used.

Moreover, in order to approximately obtain a non-flat quadratic curve from a few measurement points, it is necessary to increase the range of variation of the focus position. However, since the defocus margin of the optical pickup, or the like, varies from one apparatus to another, a recording error may occur in an individual apparatus when there is excessive defocusing from the focus position at which the light beam is focused on the recording surface of the optical disc during recording.

The present invention has been made in view of the above, and has an object to ensure that the optimum recording focus position is obtained properly.

### Means for Solving the Problems

In order to achieve the object set forth above, a first embodiment of the present invention is directed to an optical disc signal processing device for controlling recording/reproduction of an optical disc, including: a drive control section for controlling an optical pickup; and a focus position determining section, wherein when test recording is performed while changing a focus position through a plurality of positions, the focus position determining section obtains an optimum recording focus position based on recording qualities of regions on the optical disc where the test recording has been performed, wherein the focus position determining section includes: a recording state measuring section for measuring, for each focus position, a recording quality of a region on the optical disc where the test recording has been performed; and a determination section for determining, according to a predetermined criterion, whether laser power during the test recording is suitable for obtaining the optimum recording focus position, based on the recording quality obtained for each focus position by the recording state measuring section, wherein when it is determined by the determination section that the laser power during the test recording is not suitable for obtaining the optimum recording focus position, the drive control section controls the optical pickup so that the test recording is performed again with the laser power changed.

Thus, the optical disc signal processing device controls the optical pickup so that if the test recording laser power is not suitable for obtaining the optimum recording focus position, the test recording is performed again with the laser power changed. Therefore, the test recording is performed again, and if the laser power of the test recording is suitable for obtaining the optimum recording focus position, the optimum recording focus position is obtained properly based on the recording qualities of the regions where the test recording has been performed.

A second embodiment of the present invention is directed to an optical disc signal processing device for controlling recording/reproduction of an optical disc, including: a drive control section for controlling an optical pickup; a focus position determining section, wherein when test recording is performed while changing a focus position through a plurality of positions, the focus position determining section obtains an optimum recording focus position based on recording qualities of regions on the optical disc where the test recording has been performed; and a recording completion determining section for determining whether a recording operation has been completed normally for each focus position in the test recording, wherein if there is a focus position among the plurality of focus positions at which it has been determined by the recording completion determining section that the recording operation has not been completed normally, the drive control section controls the optical pickup so that the test recording is performed again with a range of focus positions changed so as to exclude the focus position at which it has been determined by the recording completion determining section that the recording operation has not been completed normally.

Thus, if it is determined that the recording operation has not been completed normally for a focus position, the test recording is performed again with the range of focus positions changed so as to exclude the focus position, and the optimum recording focus position is obtained based on the recording qualities of the regions on the optical disc where the test recording has been performed. This reduces the possibility that the recording quality of a region on the optical disc where recording has not been performed normally is used for obtaining the optimum recording focus position, whereby it is possible to properly obtain the optimum recording focus position.

### EFFECTS OF THE INVENTION

According to the present invention, if the test recording laser power is not suitable for obtaining the optimum recording focus position, the test recording is performed again with the laser power changed. The test recording is performed again, and if the test recording laser power is suitable for obtaining the optimum recording focus position, the optimum recording focus position can be obtained properly based on the recording qualities of the regions where the test recording has been performed.

### BRIEF DESCRIPTION OF THE DRAWINGS

FIG. 1 is a block diagram showing a configuration of an optical disc device according to Embodiment 1 of the present invention.

FIG. 2 is a graph showing the waveform of the RF signal output from a reproduction signal processing section 103 according to Embodiment 1 of the present invention.

FIG. 3 is a block diagram showing a configuration of a recording state measuring section 107 according to Embodiment 1 of the present invention.

FIG. 4 illustrates the relationship between the recording focus position and the degree of modulation according to Embodiment 1 of the present invention.

FIG. 5 illustrates the relationship between the recording focus position and the degree of modulation according to Embodiment 1 of the present invention.

FIG. 6 is a table showing the relationship between the laser power, the degree of modulation for each recording focus position, and the pole of the approximate equation, according to Embodiment 1 of the present invention.

FIG. 7 is a flow chart showing an operation of an optical disc device according to Embodiment 1 of the present invention.

FIG. 8 is a block diagram showing a configuration of an optical disc device according to Embodiment 2 of the present invention.

FIG. 9 is a flow chart showing an operation of an optical disc device according to Embodiment 2 of the present invention.

FIG. 10 is a block diagram showing a configuration of an optical disc device according to Embodiment 3 of the present invention.

FIG. 11 is a flow chart showing an operation of an optical disc device according to Embodiment 3 of the present invention.

FIG. 12 is a block diagram showing a configuration of an optical disc device according to Embodiment 4 of the present invention.

FIG. 13 illustrates the relationship between the degree of modulation and the focus position, measured when the optimum recording focus position is shifted in the positive direction according to Embodiment 4 of the present invention.

FIG. 14 illustrates the relationship between the degree of modulation and the focus position across the range of variation of the recording focus position which is shifted in the positive direction according to Embodiment 4 of the present invention.

FIG. 15 illustrates the relationship between the degree of modulation and the focus position, measured when the optimum recording focus position is shifted in the negative direction according to Embodiment 4 of the present invention.

FIG. 16 illustrates the relationship between the degree of modulation and the focus position across the range of variation of the recording focus position which is shifted in the negative direction according to Embodiment 4 of the present invention.

FIG. 17 illustrates the relationship between the degree of modulation and the focus position measured when the margin of the recording focus position for normal recording is small according to Embodiment 4 of the present invention.

FIG. 18 illustrates the relationship between the degree of modulation and the focus position across the narrowed range of variation of the recording focus position according to Embodiment 4 of the present invention.

### DESCRIPTION OF REFERENCE NUMERALS

100 Optical disc signal processing device
101 Optical disc
102 Optical pickup
103 Reproduction signal processing section
104 Laser control section
105 Driving section
106 Focus control section
107 Recording state measuring section
108 Measurement results storing section
109 Approximate equation calculating section
110 Optimum recording focus position calculating section
111 Measurement results judging section
112 Drive control section
113 Peak holding section
114 Bottom holding section
115 A/D converter
116 A/D converter
117 Modulation degree calculating section
118 Focus position determining section
200 Optical disc signal processing device
201 Measurement results judging section
202 Focus position determining section
300 Optical disc signal processing device
301 Approximate equation coefficient judging section
302 Focus position determining section
400 Optical disc signal processing device
401 Recording completion determining section
402 Focus position determining section

### BEST MODE FOR CARRYING OUT THE INVENTION

Embodiments of the present invention will now be described with reference to the drawings. In each embodiment below, elements similar in function to those of other embodiments will be denoted by the same reference numerals and will not be described repeatedly.

### Embodiment 1

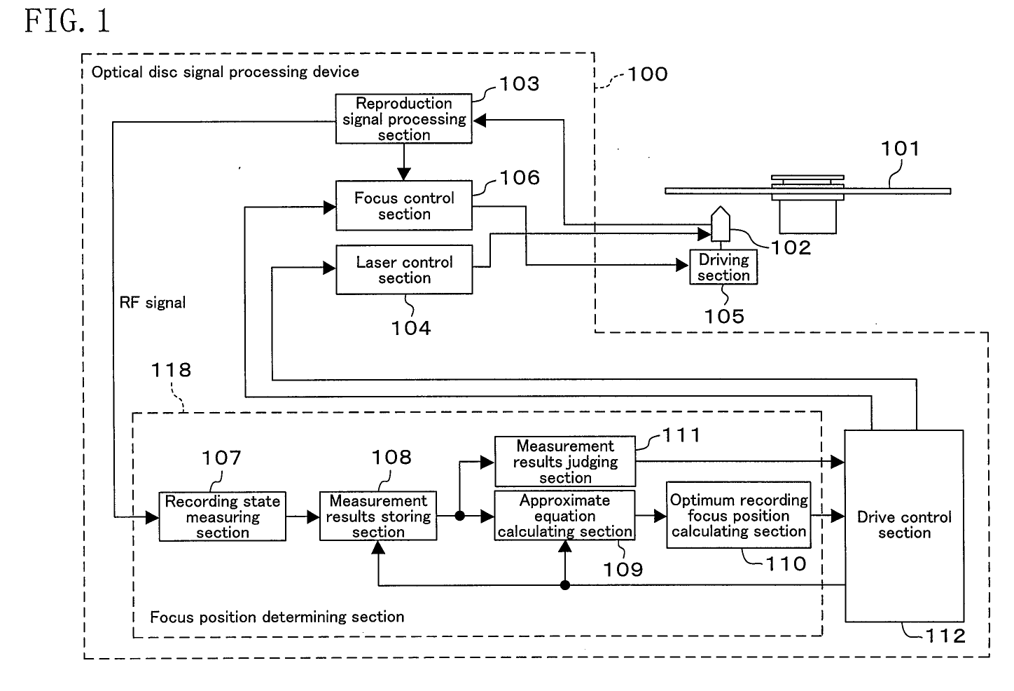

As shown in FIG. 1, the optical disc device of the present embodiment can receive an optical disc 101, and includes an optical pickup 102, a reproduction signal processing section 103, a laser control section 104, a driving section 105, a focus control section 106, a recording state measuring section 107, a measurement results storing section 108, an approximate equation calculating section 109, an optimum recording focus position calculating section 110, a measurement results judging section 111, and a drive control section 112. The reproduction signal processing section 103, the laser control section 104, the focus control section 106, the recording state measuring section 107, the measurement results storing section 108, the approximate equation calculating section 109, the optimum recording focus position calculating section 110, the measurement results judging section 111, and the drive control section 112 together form an optical disc signal processing device 100.

More specifically, the optical disc device is a computer system including a microprocessor, a ROM (Read-Only Memory), a RAM (Random-Access Memory), an optical disc drive unit, etc. The optical disc signal processing device 100 is implemented by an LSI (Large Scale Integration) being an integrated circuit. The function of each of these sections is realized by the microprocessor operating according to a computer program stored in the RAM. The functional blocks included in the optical disc signal processing device 100 may each be separately provided as a single chip, or some or all of the functional blocks may be provided as a single chip. The optical disc signal processing device 100 is not limited to the integrated circuit of the scale called an “LSI”, but may be an integrated circuit called an “IC”, a “system LSI”, a “super LSI”, an “ultra LSI”, etc. Moreover, if advancements in the semiconductor technology or derivative technologies bring forth a new form of circuit integration replacing LSIs, the new form of circuit integration can be used for the integration of the functional blocks. For example, biotechnology may possibly be applied to circuit integration.

The optical disc 101 is an optical disc that uses a laser beam for reading and writing information, such as a CD-R, a CD-RW, a DVD-RAM, a DVD-R, a DVD-RW, a DVD+R or a DVD+RW.

During reproduction and recording, the optical pickup 102 irradiates the information recording surface of the optical disc 101 with a laser beam according to an instruction from the laser control section 104 regarding the intensity and the output timing of the laser beam, etc. Then, reflected light from the optical disc 101 is read by a photodetector provided inside, where the reflected light is converted into an RF signal. The optical pickup 102 receives, by means of the photodetector, light which has been reflected/diffracted by the guide grooves of the optical disc 101, and converts the received light into control signals. The control signals include signals used for controlling the position of the optical pickup 102, such as a focus control signal and a tracking control signal.

The reproduction signal processing section 103 outputs the RF signal from the optical pickup 102 to the recording state measuring section 107. The reproduction signal processing section 103 also outputs the control signal from the optical pickup 102 to the focus control section 106.

The laser control section 104 receives velocity information representing the linear velocity of the optical disc 101 stored in the drive control section 112. Then, the laser control section 104 instructs the optical pickup 102 to output a laser beam with the intensity and the output timing corresponding to the linear velocity represented by the velocity information.

The driving section 105 is implemented by an actuator, and controls the focus according to an instruction from the focus control section 106. Specifically, the driving section 105 moves the position of the lens in the optical pickup 102 according to the instruction from the focus control section 106.

The focus control section 106 receives the control signal output from the reproduction signal processing section 103, and receives from the drive control section 112 the velocity information representing the linear velocity of the optical disc 101 and operation information including the identifier of data to be read or written, to control the driving section 105. More specifically, the focus control section 106 gives the driving section 105 an instruction regarding the control of the position of the optical pickup 102 so that data is read or written by the optical pickup 102 at a linear velocity represented by the velocity information.

The recording state measuring section 107 measures the degree of modulation as a value representing the recording quality of the recorded signal based on the RF signal output from the reproduction signal processing section 103.

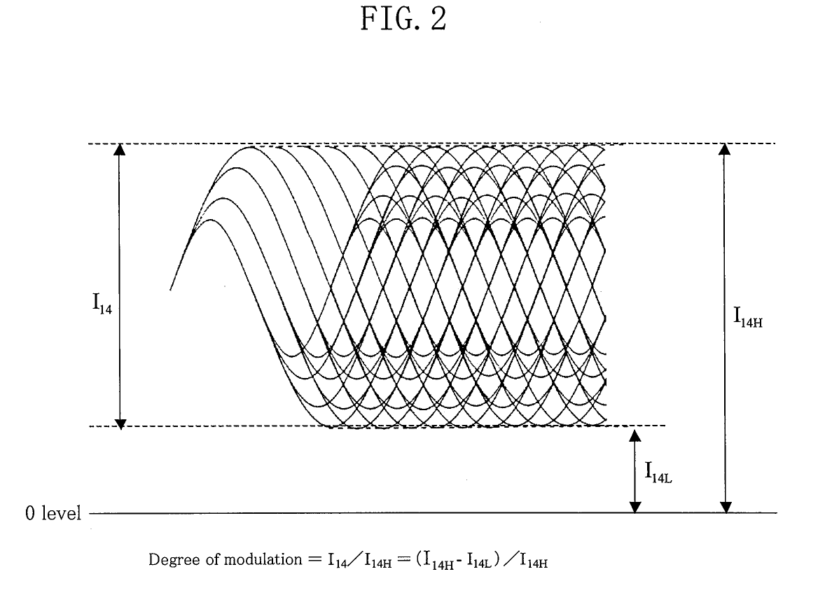

With respect to the read clock signal cycle (1T), each recording mark recorded on the optical disc 101 corresponds to a period of 3T to 14T.

Where the amplitude of the signal waveform corresponding to the period of 14T is represented as 114 as shown in FIG. 2, the degree of modulation is represented as I₁₄/I_{14H}. A higher degree of modulation means a larger signal waveform amplitude and a better signal recording quality, i.e., a better state of the RF signal.

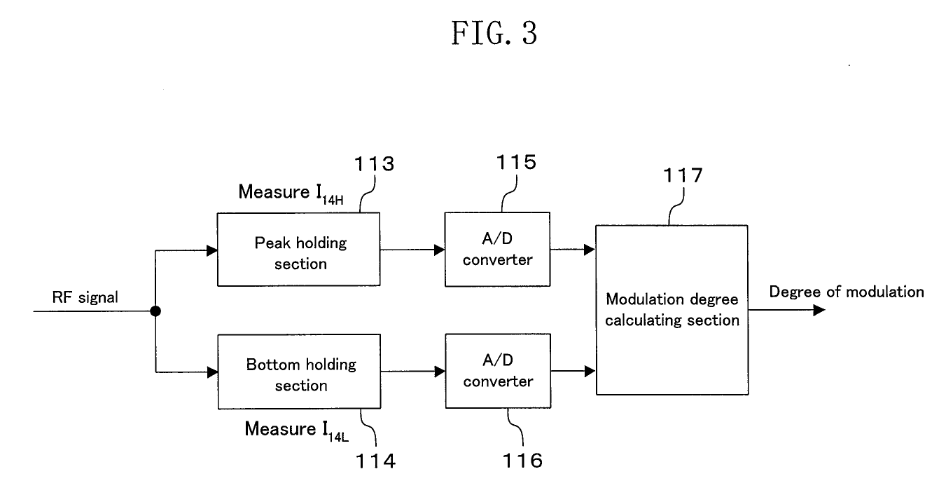

As shown in FIG. 3, the recording state measuring section 107 includes a peak holding section 113, a bottom holding section 114, an A/D converter 115, an A/D converter 116, and a modulation degree calculating section 117.

The peak holding section 113 obtains I_{14H} by performing a peak detection operation on the RF signal, and the bottom holding section 114 obtains I_{14L} by performing a bottom detection operation on the RF signal.

The A/D converter 115 digitalizes I_{14H} obtained by the peak holding section 113, and the A/D converter 116 digitalizes I_{14L} obtained by the bottom holding section 114.

The modulation degree calculating section 117 obtains the degree of modulation based on the following expression.

Degree of modulation=I₁₄/I_{14H}=(I_{14H}−I_{14L})/I_{14H}

The measurement results storing section 108 receives the recording focus position when the RF signal is recorded from the drive control section 112, at the time of receiving the degree of modulation representing the state of the RF signal obtained by the recording state measuring section 107. The measurement results storing section 108 stores the degree of modulation and the recording focus position as a set. The measurement results storing section 108 is capable of storing a plurality of sets of the degree of modulation and the recording focus position.

The approximate equation calculating section 109 receives seven sets of the degree of modulation and the recording focus position stored in the measurement results storing section 108, and obtains the quadratic approximate equation Y=a*X*X+b*X+c, where the X axis is the recording focus position [μm] and the Y axis is the degree of modulation [%], based on these sets by using the least squares method. The least squares method is a technique known in the art, and will not be described herein.

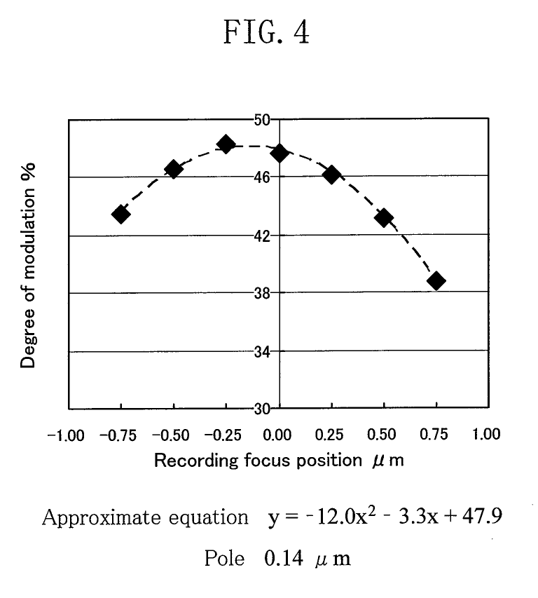

In the present embodiment, the optical disc device performs recording while changing the recording focus position through seven steps, and the approximate equation calculating section 109 obtains an approximate equation based on the seven sets of the degree of modulation and the recording focus position stored in the measurement results storing section 108. FIG. 4 shows the degrees of modulation stored in the measurement results storing section 108 while being associated with different recording focus positions, the quadratic approximate equation obtained by the approximate equation calculating section 109, and the recording focus position corresponding to the pole of the curve representing the approximate equation.

The optimum recording focus position calculating section 110 receives the quadratic approximate equation obtained by the approximate equation calculating section 109, obtains the value −0.5*b/a representing the recording focus position corresponding to the pole of the curve representing the approximate equation, and transmits the obtained value as the optimum recording focus position to the drive control section 112. In the example of FIG. 4, the value representing the optimum recording focus position is −0.14 μm.

The measurement results judging section 111 receives the seven degrees of modulation stored in the measurement results storing section 108, and determines whether the received seven degrees of modulation are of values suitable for use in obtaining the approximate equation at the approximate equation calculating section 109, i.e., whether the seven degrees of modulation are suitable for obtaining the optimum recording focus position. In other words, the measurement results judging section 111 determines whether the laser power of the test recording performed for obtaining the seven degrees of modulation is suitable for obtaining the optimum recording focus position.

Specifically, the measurement results judging section 111 receives the seven degrees of modulation associated with seven recording focus positions from the measurement results storing section 108, and determines whether the difference between the maximum value and the minimum value of the received seven degrees of modulation is less than or equal to 6% and one or more of the seven degrees of modulation are greater than or equal to 50%. If the difference between the maximum value and the minimum value is less than or equal to 6% and one or more degrees of modulation are greater than or equal to 50%, the measurement results judging section 111 outputs to the drive control section 112 a determination result that the test recording laser power is too high and not suitable for obtaining the optimum recording focus position. Moreover, the measurement results judging section 111 receives the seven degrees of modulation associated with seven recording focus positions from the measurement results storing section 108, and determines whether the difference between the maximum value and the minimum value of the received seven degrees of modulation is less than or equal to 6% and one or more of the seven degrees of modulation are less than or equal to 50% degree of modulation. If the difference between the maximum value and the minimum value is less than or equal to 6% and one or more degrees of modulation are less than or equal to 50%, the measurement results judging section 111 outputs to the drive control section 112 a determination result that the test recording laser power is too low and not suitable for obtaining the optimum recording focus position.

The recording state measuring section 107, the measurement results storing section 108, the approximate equation calculating section 109, the optimum recording focus position calculating section 110 and the measurement results judging section 111 together form a focus position determining section 118.

The drive control section 112 controls the laser power of the optical pickup and the driving thereof by issuing instructions to the laser control section 104 and the focus control section 106. If a determination result that the recording laser power is too high and not suitable for obtaining the optimum recording focus position is output from the measurement results judging section 111, the drive control section 112 instructs the measurement results storing section 108 to discard the seven sets of data of the degree of modulation and the recording focus position and instructs the approximate equation calculating section 109 to stop calculation. Then, the drive control section 112 instructs the laser control section 104 and the focus control section 106 so that recording is performed again with the laser power lowered by 3 mW. If a determination result that the recording laser power is too low and not suitable for obtaining the optimum recording focus position is output from the measurement results judging section 111, the drive control section 112 instructs the measurement results storing section 108 to discard the seven sets of data of the degree of modulation and the recording focus position and instructs the approximate equation calculating section 109 to stop calculation. Then, the drive control section 112 instructs the laser control section 104 and the focus control section 106 so that recording is performed again with the laser power raised by 3 mW. If a determination result that the recording laser power is suitable for obtaining the optimum recording focus position is output from the measurement results judging section 111, the drive control section 112 receives from the optimum recording focus position calculating section 110 a signal representing the optimum recording focus position obtained based on the seven sets of the degree of modulation and the recording focus position stored in the measurement results storing section 108, and instructs the focus control section 106 so that the optimum recording focus position is thereafter used as the recording focus position.

Moreover, the drive control section 112 controls the overall operation of the optical disc device for reading out data from the optical disc 101 and writing data to the optical disc 101. Furthermore, the drive control section 112 stores drive control information such as the velocity information representing the linear velocity of the optical disc 101, and operation information including the identifier of data to be read or written.

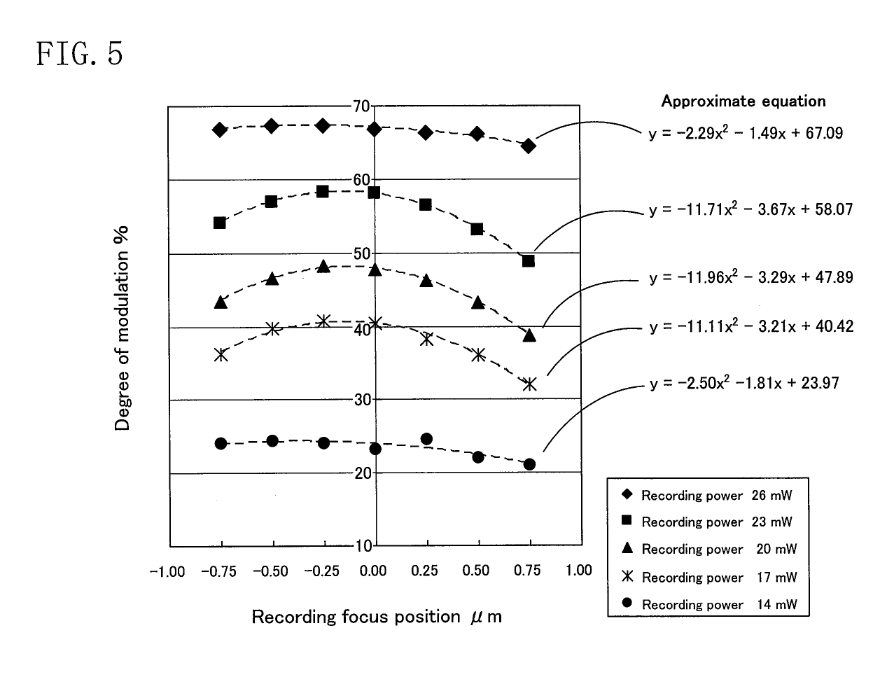

FIG. 5 shows degrees of modulation stored in the measurement results storing section 108 while being associated with different recording focus positions, when recording is performed with different laser powers, and the quadratic approximate equations obtained by the approximate equation calculating section 109.

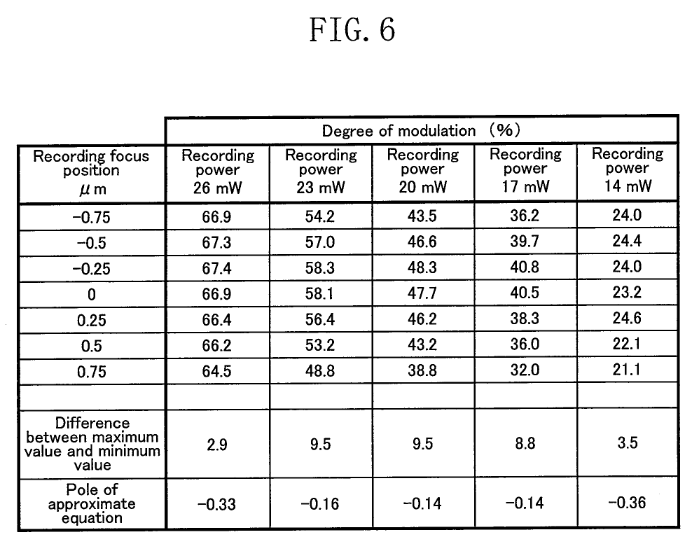

FIG. 6 is a table showing the relationship between the laser power, the degree of modulation associated with each recording focus position, and the optimum recording focus position (the pole of the approximate equation) obtained by the optimum recording focus position calculating section 110.

As shown in FIG. 6, for recording laser powers (recording powers) of 23 mW, 20 mW and 17 mW, the optimum recording focus positions are −0.16 μm, −0.14 μm and −0.14 μm, respectively. For a recording laser power of 26 mW, the obtained optimum recording focus position is −0.33 μm, being different from others by 0.17 μm or more. As shown in the graph of FIG. 5, with a recording laser power of 26 mW, the power is too high, and the degree of modulation does not vary substantially through the seven steps of the recording focus position. If a quadratic approximate equation is obtained by the least squares method using such degrees of modulation, the curve representing the approximate equation will be flat, whereby the coordinates of the pole are likely to vary due to measurement errors. Thus, the obtained optimum recording focus position is likely to vary substantially due to measurement errors.

Where the recording laser power is low, the recording state is poor irrespective of the recording focus position. As shown in FIG. 6, where the recording laser power is 14 mW, the obtained optimum recording focus position is −0.36 μm, being substantially different from others. As shown in the graph of FIG. 5, where the recording laser power of 14 mW, being the initial value, is too low for the recording, and the degree of modulation does not vary substantially and stays around 23% through the seven steps of the recording focus position. If a quadratic approximate equation is obtained by the least squares method using the degree of modulation that does not vary substantially in response to a change in the recording focus position, the curve representing the approximate equation will be flat, whereby the coordinates of the pole are likely to vary due to measurement errors. Thus, the optimum recording focus position whose value corresponds to the coordinates of the pole is also likely to vary substantially due to measurement errors.

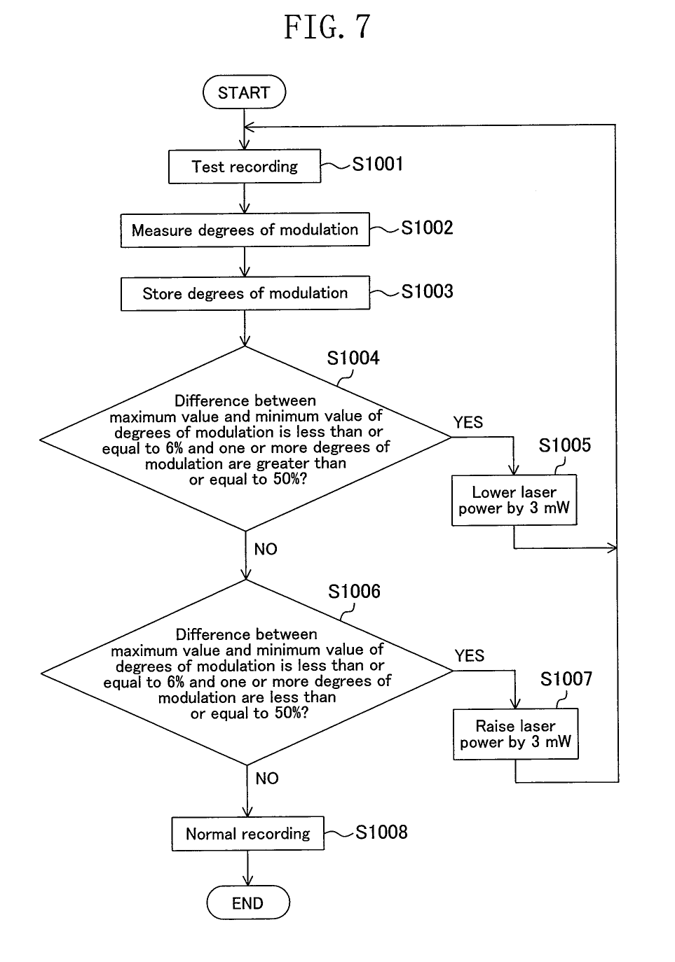

An operation of the optical disc device of the present embodiment will now be described with reference to the flow chart of FIG. 7.

(S1001) The optical disc device performs test recording on the optical disc 101 with a constant laser power while successively changing the focus position through seven steps. Test recording is performed while the laser control section 104 controls the optical pickup 102 and the focus control section 106 controls the driving section 105 in response to an instruction from the drive control section 112.

(S1002) The recording state measuring section 107 measures, for each focus position, the degree of modulation representing the recording state of the region on the optical disc 101 where test recording has been performed.

(S1003) The measurement results storing section 108 stores the seven degrees of modulation, being the measurement results obtained by the recording state measuring section 107, while the seven degrees of modulation are associated with the respective focus positions.

(S1004) The measurement results judging section 111 determines whether the difference between the maximum value and the minimum value of the seven degrees of modulation stored in the measurement results storing section 108 is less than or equal to 6% and one or more of the seven degrees of modulation are greater than or equal to 50%. The process proceeds to (S1005) if the difference between the maximum value and the minimum value of the seven degrees of modulation is less than or equal to 6% and one or more of the seven degrees of modulation are greater than or equal to 50%, and the process proceeds to (S1006) otherwise.

(S1005) The drive control section 112 instructs the measurement results storing section 108 to discard data representing the seven degrees of modulation. Moreover, the drive control section 112 instructs the laser control section 104 and the focus control section 106 so that test recording of (S1001) is started again with the laser power lowered by 3 mW.

(S1006) The measurement results judging section 111 determines whether the difference between the maximum value and the minimum value of the seven degrees of modulation stored in the measurement results storing section 108 is less than or equal to 6% and one or more of the seven degrees of modulation are less than or equal to 50%. The process proceeds to (S1007) if the difference between the maximum value and the minimum value of the seven degrees of modulation is less than or equal to 6% and one or more of the seven degrees of modulation are less than or equal to 50%, and the process proceeds to (S1008) otherwise.

(S1007) The drive control section 112 instructs the measurement results storing section 108 to discard data representing the seven degrees of modulation. Moreover, the drive control section 112 instructs the laser control section 104 and the focus control section 106 so that test recording of (S1001) is performed again with the laser power raised by 3 mW.

(S1008) The optical disc signal processing device 100 controls the driving section 105 so that the focus position corresponds to the pole of the approximate curve obtained based on the seven degrees of modulation during data recording.

For example, where the recording laser power is 26 mW, being too high for obtaining the optimum recording focus position, the maximum value and the minimum value of the degrees of modulation obtained by changing the recording focus position through seven steps by 0.25 μm between −0.75 μm and +0.75 μm are 67.4% and 64.5%, respectively, and the difference between the maximum value and the minimum value is 2.9%, meeting the criterion of being less than or equal to 6%. Moreover, the maximum value is 67.4%, also meeting the criterion that one or more degrees of modulation are greater than or equal to 50%. In this case, since the criterion that the difference between the maximum value and the minimum value is less than or equal to 6% and one or more degrees of modulation are greater than or equal to 50% is met, the measurement results judging section 111 outputs to the drive control section 112 a determination result that the recording laser power is too high and not suitable for obtaining the optimum recording power. Then, recording is performed with the laser power lowered by 3 mW to re-measure the degrees of modulation in response to an instruction from the drive control section 112. The maximum value and the minimum value of the degrees of modulation obtained by the re-measurement are 58.3% and 48.8%, respectively, as shown in FIG. 6 being associated with the recording power of 23 mW, and the difference between the maximum value and the minimum value is 9.5%, not meeting the criterion of being less than or equal to 6%. Therefore, in this case, the measurement results judging section 111 outputs to the drive control section 112 a determination result that the recording laser power is suitable for obtaining the optimum recording power. Then, based on the re-measured degrees of modulation, the approximate equation calculating section 109 obtains a quadratic approximate equation by the least squares method. Then, based on the obtained approximate equation, the optimum recording focus position calculating section 110 obtains the optimum recording focus position.

Where the recording laser power is 14 mW, being too low for obtaining the optimum recording focus position, the maximum value and the minimum value of the degrees of modulation obtained by changing the recording focus position through seven steps by 0.25 μm between −0.75 μm and +0.75 μm are 24.6% and 21.1%, respectively, and the difference between the maximum value and the minimum value is 3.5%, meeting the criterion of being less than or equal to 6%. Moreover, the minimum value is 21.1%, also meeting the criterion that one or more degrees of modulation are less than or equal to 50%. In this case, since the criterion that the difference between the maximum value and the minimum value is less than or equal to 6% and one or more degrees of modulation are less than or equal to 50% is met, a determination result that the recording laser power is too low and not suitable for obtaining the optimum recording power is output to the drive control section 112. Then, recording is performed with the laser power raised by 3 mW in response to an instruction from the drive control section 112 to re-measure the degrees of modulation. The maximum value and the minimum value of the re-measured degrees of modulation are 40.8% and 32.0%, respectively, as shown in FIG. 6 being associated with the recording power of 17 mW, and the difference between the maximum value and the minimum value is 8.8%, not meeting the criterion of being less than or equal to 6%. Therefore, in this case, the measurement results judging section 111 outputs to the drive control section 112 a determination result that the recording laser power is suitable for obtaining the optimum recording power. Then, based on the re-measured degrees of modulation, the approximate equation calculating section 109 obtains a quadratic approximate equation by the least squares method. Then, based on the obtained approximate equation, the optimum recording focus position calculating section 110 obtains the optimum recording focus position.

In the present embodiment, the measurement results judging section 111 determines whether the recording laser power is suitable based on a criterion that the difference between the maximum value and the minimum value of the seven degrees of modulation is less than or equal to 6% and one or more of the seven degrees of modulation are greater than or equal to 50%, and another criterion that the difference between the maximum value and the minimum value of the seven degrees of modulation is less than or equal to 6% and one or more of the seven degrees of modulation are less than or equal to 50%. However, the criteria are not limited thereto. For example, whether four or more of the seven degrees of modulation are greater than or equal to 50% and whether four or more of the seven degrees of modulation are less than 50% may be determined, instead of determining whether one or more of the seven degrees of modulation are greater than or equal to 50% and whether one or more of the seven degrees of modulation are greater than or equal to 50%.

The criteria are preferably derived in advance by experiments, etc. For example, the relationship between the recording focus position and the degree of modulation may be obtained with various types of discs by using various recording laser powers, and the process may obtain, based on the experiment results, the difference between the maximum value and the minimum value such that the results of the least squares method can be obtained stably and the degree of modulation such that whether the laser power is high or low can be determined reliably. The way of deriving criteria is not limited to experiments, but the criteria may be derived from simulation, etc.

Since an optical disc device is influenced by circuit offset, chromatic aberration, etc., the optimum focus position during recording needs to be obtained separately from that during reproduction. If the relationship between the value representing the recording state and the recording focus position is approximated to a quadratic equation by the least squares method, and the focus position corresponding to the pole of the curve representing the quadratic equation is obtained as the optimum recording focus position, it is possible to reduce the region of an optical disc and the amount of time required for the adjustment, as compared with conventional methods. However, since there are variations in the characteristics of the optical pickup and the optical disc recording characteristics, the recording laser power may be too high or too low. In such a case, the measured recording state does not vary in response to a change in the recording focus position, and the curve representing the quadratic equation will be flat, whereby the focus position corresponding to the pole of the curve will be substantially shifted from the optimum recording focus position.

Based on the maximum value and the minimum value of the obtained degrees of modulation, the optical disc device of the present embodiment determines whether the optimum recording focus position can be obtained based on the obtained degrees of modulation. If the obtained degrees of modulation are not suitable, recording is performed again with the laser power changed to obtain degrees of modulation again. Thus, it is possible to appropriately obtain the optimum recording focus position even if there are variations in the characteristics of the optical pickup and the optical disc recording characteristics.

### Embodiment 2

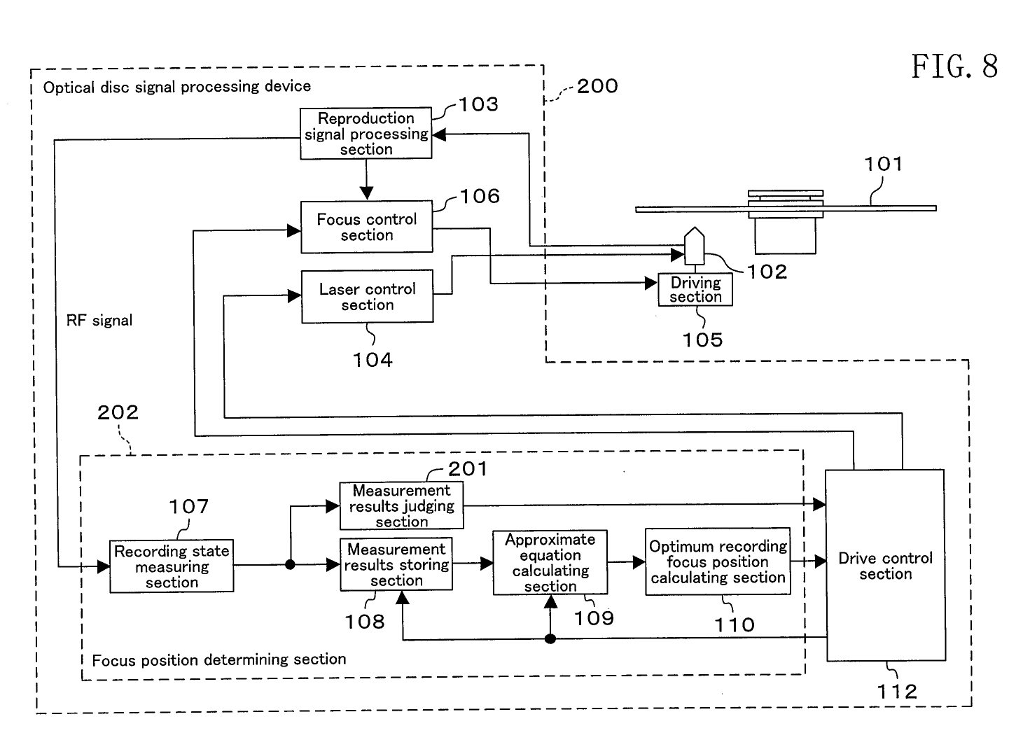

As shown in FIG. 8, an optical disc device according to Embodiment 2 of the present invention includes an optical disc signal processing device 200, instead of the optical disc signal processing device 100 of Embodiment 1. The optical disc signal processing device 200 includes a measurement results judging section 201, instead of the measurement results judging section 111 of the optical disc signal processing device 100. The recording state measuring section 107, the measurement results storing section 108, the approximate equation calculating section 109, the optimum recording focus position calculating section 110 and the measurement results judging section 201 together form a focus position determining section 202.

The optical disc device of the present embodiment is also a computer system including a microprocessor, a ROM, a RAM, an optical disc drive unit, etc. The optical disc signal processing device 200 is implemented by an LSI being an integrated circuit. The function of each of these sections is realized by the microprocessor operating according to a computer program stored in the RAM. The functional blocks included in the optical disc signal processing device 200 may each be separately provided as a single chip, or some or all of the functional blocks may be provided as a single chip. The optical disc signal processing device 200 is not limited to the integrated circuit of the scale called an “LSI”, but may be an integrated circuit called an “IC”, a “system LSI”, a “super LSI”, an “ultra LSI”, etc. Moreover, if advancements in the semiconductor technology or derivative technologies bring forth a new form of circuit integration replacing LSIs, the new form of circuit integration can be used for the integration of the functional blocks. For example, biotechnology may possibly be applied to circuit integration.

The measurement results judging section 201 receives degrees of modulation directly from the recording state measuring section 107. Each time the degree of modulation is measured, the measurement results judging section 201 determines whether the measured degree of modulation is greater than or equal to 60% and whether the degree of modulation is less than or equal to 30%.

Specifically, the measurement results judging section 201 receives the degree of modulation from the recording state measuring section 107, and determines whether the degree of modulation is greater than or equal to 60%. If the degree of modulation is greater than or equal to 60%, the measurement results judging section 201 outputs to the drive control section 112 a determination result that the recording laser power is too high and not suitable for obtaining the optimum recording focus position. Moreover, the measurement results judging section 201 receives the degree of modulation from the recording state measuring section 107, and determines whether the degree of modulation is less than or equal to 30%. If the degree of modulation is less than or equal to 30%, the measurement results judging section 201 outputs to the drive control section 112 a determination result that the recording laser power is too low and not suitable for obtaining the optimum recording focus position.

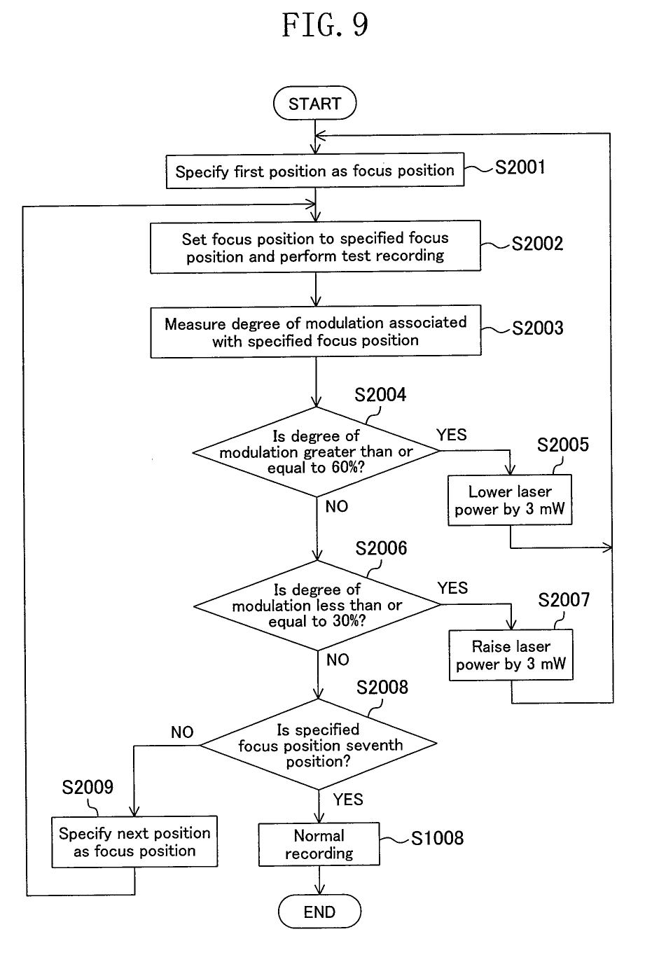

An operation of the optical disc device of the present embodiment will now be described with reference to the flow chart of FIG. 9. Operations denoted by the same reference numerals as those in the flow chart of FIG. 7, are similar to those described in Embodiment 1 and will not be further described below.

(S2001) The optical disc device specifies, as the focus position, the first one of the seven positions.

(S2002) The optical disc device sets the focus position to the specified position and performs test recording with a set laser power.

(S2003) The recording state measuring section 107 measures the degree of modulation associated with the specified focus position.

(S2004) The measurement results judging section 201 determines whether the degree of modulation measured in (S2003) by the recording state measuring section 107 is greater than or equal to 60%. The process proceeds to (S2005) if the degree of modulation is greater than or equal to 60%, and the process proceeds to (S2006) if the degree of modulation is less than 60%.

(S2005) The optical disc device sets the laser power during test recording to a value lowered by 3 mW.

(S2006) The measurement results judging section 201 determines whether the degree of modulation obtained by the recording state measuring section 107 is less than or equal to 30%. The process proceeds to (S2007) if the degree of modulation is less than or equal to 30%, and the process proceeds to (S2008) if the degree of modulation is greater than 30%.

(S2007) The optical disc device sets the laser power during test recording to a value raised by 3 mW.

(S2008) The measurement results judging section 201 determines whether the specified focus position is the seventh one of the seven positions. The process proceeds to (S1008) if the specified focus position is the seventh position, and the process proceeds to (S2009) if the specified focus position is not the seventh position.

(S2009) The optical disc device specifies, as the focus position, the next one of the seven positions.

The optical disc device of the present embodiment performs test recording while changing the focus position through seven steps, wherein each time test recording is performed at one of the seven focus positions, the degree of modulation of the region on which the test recording is performed is measured. If a degree of modulation greater than or equal to 60% is measured, the measurement results judging section 201 determines that the recording laser power is too high and not suitable for obtaining the optimum focus position. If a degree of modulation less than or equal to 30% is measured, the measurement results judging section 201 determines that the recording laser power is too low and not suitable for obtaining the optimum focus position.

As described above with reference to FIG. 5, when the recording laser power is 26 mW, the obtained optimum recording focus position is likely to vary substantially due to measurement errors. Where the recording laser power is 26 mW, the degree of modulation for a recording focus position of −0.75 μm is 66.9%, meeting the criterion of being greater than or equal to 60%. In this case, the measurement results judging section 201 outputs to the drive control section 112 a determination result that the recording laser power is too high and not suitable for obtaining the optimum recording focus position. Then, the degree of modulation is re-measured with the laser power lowered by 3 mW in response to an instruction from the drive control section 112. The maximum value of the seven re-measured degrees of modulation is 58.3%, as shown in FIG. 6 being associated with the recording power of 23 mW. Thus, the seven degrees of modulation do not include one that meets the criterion of being greater than or equal to 60%. Therefore, in this case, a determination result that the measured seven degrees of modulation are suitable for obtaining an approximate equation is output to the drive control section 112. Then, based on the re-measured degrees of modulation, the approximate equation calculating section 109 obtains a quadratic approximate equation by the least squares method. Then, based on the obtained approximate equation, the optimum recording focus position calculating section 110 obtains the optimum recording focus position.

As described above with reference to FIG. 5, when the recording laser power is 14 mW, the obtained optimum recording focus position is likely to vary substantially due to measurement errors. Where the recording laser power is 14 mW, the degree of modulation for a recording focus position of −0.75 mW is 24.0%, meeting the criterion of being less than or equal to 30%. In this case, the measurement results judging section 201 outputs to the drive control section 112 a determination result that the recording laser power is too low and not suitable for obtaining the optimum recording focus position. Then, recording is performed with the laser power raised by 3 mW in response to an instruction from the drive control section 112 to re-measure the degrees of modulation. The minimum value of the seven re-measured degrees of modulation is 32.0%, as shown in FIG. 6 being associated with the recording power of 17 mW. Thus, the seven degrees of modulation do not include one that meets the criterion of being less than or equal to 30%. Therefore, in this case, a determination result that the measured seven degrees of modulation are suitable for obtaining an approximate equation is output to the drive control section 112. Then, based on the re-measured degrees of modulation, the approximate equation calculating section 109 obtains a quadratic approximate equation by the least squares method. Then, based on the obtained approximate equation, the optimum recording focus position calculating section 110 obtains the optimum recording focus position.

In the present embodiment, the measurement results judging section 201 determines whether the recording laser power is suitable based on the criterion whether at least one of the seven degrees of modulation associated with the seven focus positions is greater than or equal to 60% and the criterion whether at least one of the seven degrees of modulation is less than or equal to 30%. However, the criteria are not limited thereto. The criteria are preferably derived in advance by experiments, etc. For example, the relationship between the recording focus position and the degree of modulation may be obtained with various types of discs by using various recording laser powers, and the process may obtain, based on the experiment results, the range of the degree of modulation across which results of the least squares method can be obtained stably. The way of deriving criteria is not limited to experiments, but the criteria may be derived from simulation, etc.

### Embodiment 3

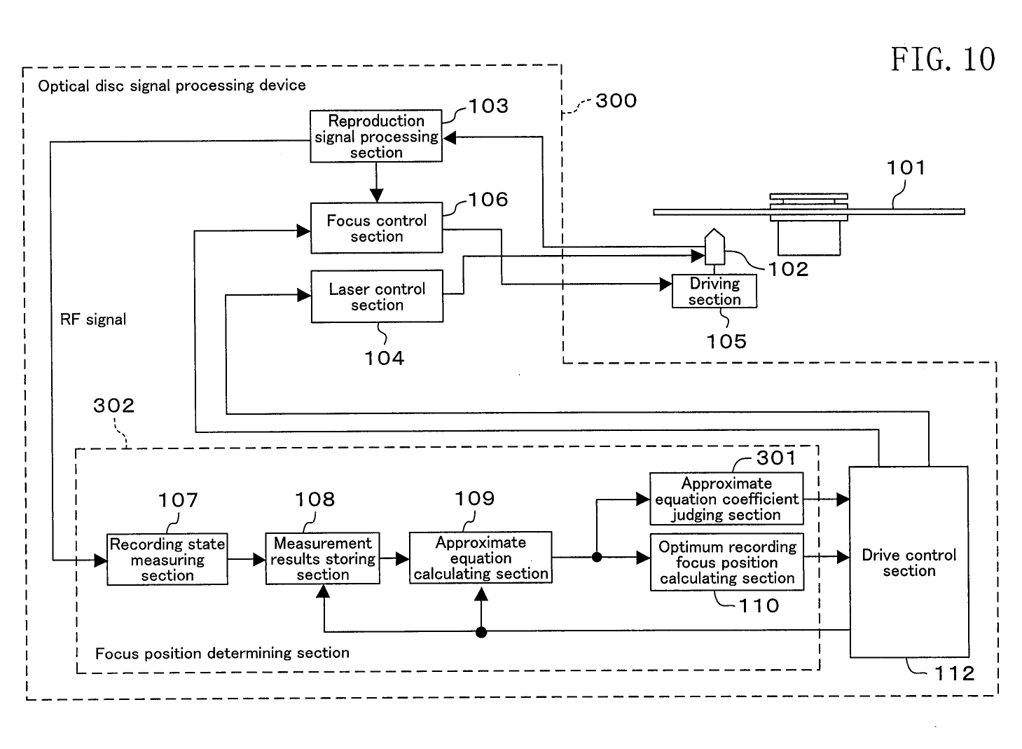

As shown in FIG. 10, an optical disc device according to Embodiment 3 of the present invention includes an optical disc signal processing device 300, instead of the optical disc signal processing device 100 of Embodiment 1. The optical disc signal processing device 300 includes an approximate equation coefficient judging section 301, instead of the measurement results judging section 111 of the optical disc signal processing device 100. The recording state measuring section 107, the measurement results storing section 108, the approximate equation calculating section 109, the optimum recording focus position calculating section 110 and the approximate equation coefficient judging section 301 together form a focus position determining section 302.

The optical disc device of the present embodiment is also a computer system including a microprocessor, a ROM, a RAM, an optical disc drive unit, etc. The optical disc signal processing device 300 is implemented by an LSI being an integrated circuit. The function of each of these sections is realized by the microprocessor operating according to a computer program stored in the RAM. The functional blocks included in the optical disc signal processing device 300 may each be separately provided as a single chip, or some or all of the functional blocks may be provided as a single chip. The optical disc signal processing device 300 is not limited to the integrated circuit of the scale called an “LSI”, but may be an integrated circuit called an “IC”, a “system LSI”, a “super LSI”, an “ultra LSI”, etc. Moreover, if advancements in the semiconductor technology or derivative technologies bring forth a new form of circuit integration replacing LSIs, the new form of circuit integration can be used for the integration of the functional blocks. For example, biotechnology may possibly be applied to circuit integration.

The approximate equation coefficient judging section 301 determines whether the approximate equation obtained by the approximate equation calculating section 109 is suitable for obtaining the optimum focus position based on the coefficient a and the coefficient c of the approximate equation. In other words, the measurement results judging section 111 determines whether the laser power of the test recording performed for obtaining the approximate equation is suitable for obtaining the optimum recording focus position.

Specifically, the approximate equation coefficient judging section 301 receives, from the approximate equation calculating section 109, the coefficient a and the coefficient c of the quadratic approximate equation Y=a*X*X+b*X+c, where X is the recording focus position [μm] and Y is the degree of modulation [%], and determines whether the coefficient a is greater than or equal to −7 and the coefficient c is greater than or equal to 45. If the coefficient a is greater than or equal to −7 and the coefficient c is greater than or equal to 45, the approximate equation coefficient judging section 301 outputs to the drive control section 112 a determination result that the laser power of the test recording performed for obtaining the approximate equation is too high and not suitable for obtaining the optimum recording focus position. The approximate equation coefficient judging section 301 also determines whether the coefficient a is greater than or equal to −7 and the coefficient c is less than 45. If the coefficient a is greater than or equal to −7 and the coefficient c is less than 45, the approximate equation coefficient judging section 301 outputs to the drive control section 112 a determination result that the laser power of the test recording performed for obtaining the approximate equation is too low and not suitable for obtaining the optimum recording focus position.

As described above with reference to FIG. 5, when the recording laser power is 26 mW, the obtained optimum recording focus position is likely to vary substantially due to measurement errors. As shown in FIG. 5, the coefficient a of the approximate equation Y=a*X*X+b*X+c is −2.29 for a recording laser power of 26 mW, −11.71 for a recording laser power of 23 mW, −11.96 for a recording laser power of 20 mW, and −11.11 for a recording laser power of 17 mW. Therefore, by determining whether the coefficient a is greater than or equal to −7, as described above, it is possible to appropriately determine whether the laser power of the test recording performed for obtaining the approximate equation is suitable for obtaining the optimum recording focus position.

As shown in FIG. 5, the coefficient c is 67.09 for a recording laser power of 26 mW, 58.07 for a recording laser power of 23 mW, 47.89 for a recording laser power of 20 mW, 40.42 for a recording laser power of 17 mW, and 23.97 for a recording laser power of 14 mW. Thus, the value of the coefficient c is higher as the recording laser power is higher. Therefore, by determining whether the coefficient c is greater than or equal to 45 or less than 45, as described above, it is possible to appropriately determine whether the laser power should be increased or decreased.

Where the recording laser power is low, the recording state is poor irrespective of the recording focus position. As described above with reference to FIG. 5, the curve representing the obtained approximate equation will be flat when the recording laser power is 14 mW. The coefficient a of the approximate equation Y=a*X*X+b*X+c is −2.50 for a recording laser power of 14 mW, −11.96 for a recording laser power of 20 mW, and −11.11 for a recording laser power of 17 mW. Therefore, by determining whether the coefficient a is greater than or equal to −7, as described above, it is possible to appropriately determine whether the laser power of the test recording performed for obtaining the approximate equation is suitable for obtaining the optimum recording focus position.

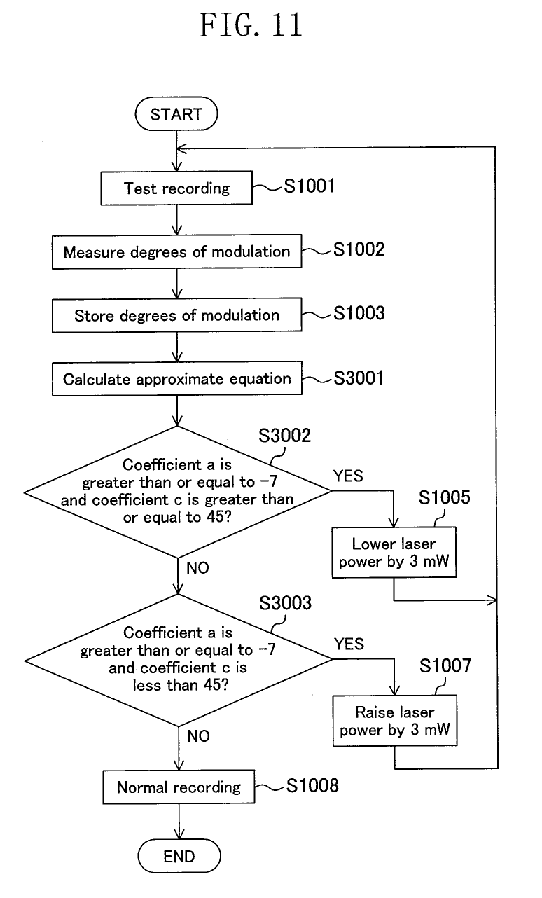

An operation of the optical disc device of the present embodiment will now be described with reference to the flow chart of FIG. 11. Operations denoted by the same reference numerals as those in the flow charts of FIGS. 7 and 9, are similar to those described in Embodiments 1 and 2 and will not be further described below.

(S3001) The approximate equation calculating section 109 obtains a quadratic approximate equation Y=a*X*X+b*X+c, where X is the recording focus position [μm] and Y is the degree of modulation [%], by using the least squares method based on the seven degrees of modulation and the seven recording focus positions stored in the measurement results storing section 108.

(S3002) The approximate equation coefficient judging section 301 determines whether the coefficient a of the approximate equation obtained by the approximate equation calculating section 109 is greater than or equal to −7 and the coefficient c of the approximate equation is greater than or equal to 45. The process proceeds to (S1005) if the coefficient a is greater than or equal to −7 and the coefficient c is greater than or equal to 45, and the process proceeds to (S3003) otherwise.

(S3003) The approximate equation coefficient judging section 301 determines whether the coefficient a of the approximate equation obtained by the approximate equation calculating section 109 is greater than or equal to −7 and the coefficient c of the approximate equation is less than 45. The process proceeds to (S1007) if the coefficient a is greater than or equal to −7 and the coefficient c is less than 45, and the process proceeds to (S1008) otherwise.

In the above description, the value of the coefficient c has been used for determining whether the laser power is high or low. Alternatively, it may be determined that the laser power is relatively high when the maximum value (local maximum value) Y=c−0.25*b*b/a, where X=−0.5*b/a, is greater than or equal to a particular value V, and it may be determined that the laser power is relatively low when it is less than or equal to a particular value W.

In the present embodiment, the measurement results judging section 201 determines whether the test recording laser power is suitable based on the criterion whether the coefficient a is greater than or equal to −7. However, the criteria are not limited thereto. The criteria are preferably derived in advance by experiments, etc. For example, the relationship between the recording focus position and the degree of modulation may be obtained with various types of discs by using various recording laser powers, and the process may obtain, based on the experiment results, the range of the degree of modulation across which results of the least squares method can be obtained stably. The way of deriving criteria is not limited to experiments, but the criteria may be derived from simulation, etc.

### Embodiment 4

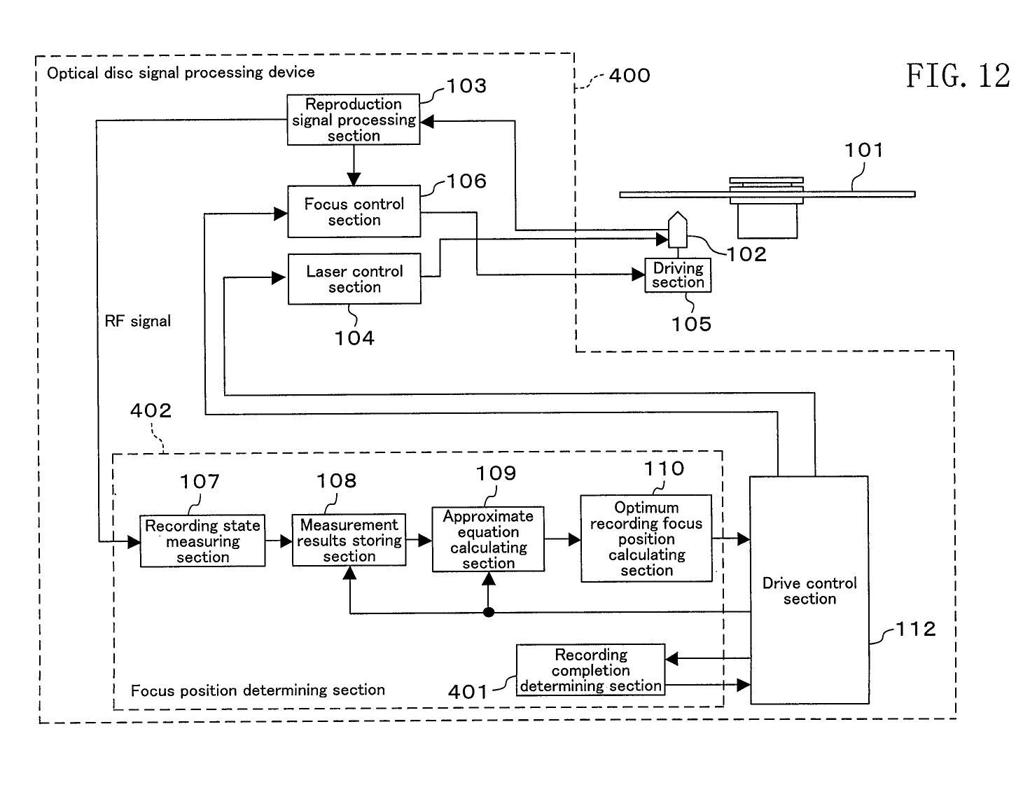

As shown in FIG. 12, an optical disc device according to Embodiment 4 of the present invention includes an optical disc signal processing device 400, instead of the optical disc signal processing device 100 of Embodiment 1. The optical disc signal processing device 400 includes a recording completion determining section 401, instead of the measurement results judging section 111 of the optical disc signal processing device 100. The recording state measuring section 107, the measurement results storing section 108, the approximate equation calculating section 109, the optimum recording focus position calculating section 110 and the recording completion determining section 401 together form a focus position determining section 402.

The optical disc device of the present embodiment is also a computer system including a microprocessor, a ROM, a RAM, an optical disc drive unit, etc. The optical disc signal processing device 400 is implemented by an LSI being an integrated circuit. The function of each of these sections is realized by the microprocessor operating according to a computer program stored in the RAM. The functional blocks included in the optical disc signal processing device 400 may each be separately provided as a single chip, or some or all of the functional blocks may be provided as a single chip. The optical disc signal processing device 400 is not limited to the integrated circuit of the scale called an “LSI”, but may be an integrated circuit called an “IC”, a “system LSI”, a “super LSI”, an “ultra LSI”, etc. Moreover, if advancements in the semiconductor technology or derivative technologies bring forth a new form of circuit integration replacing LSIs, the new form of circuit integration can be used for the integration of the functional blocks. For example, biotechnology may possibly be applied to circuit integration.

The recording completion determining section 401 determines whether a recording operation has been completed normally based on the output from the drive control section 112, and outputs the determination result to the drive control section 112. For example, where the recording is discontinued when the address can no longer be obtained during recording because of a poor quality of the RF signal due to defocusing, the drive control section 112 sends the recording completion determining section 401 information indicating that the recording has been discontinued, and the recording completion determining section 401 determines based on this information that the recording has not been completed normally and outputs the determination result to the drive control section 112.

Although test recording is performed while changing the focus position in the present embodiment, when the focus position is excessively shifted from the position at which the light beam is focused on the recording surface of the optical disc 101, the RF signal deteriorates, whereby it may become no longer possible to obtain the address information contained in the RF signal, it may become no longer possible to obtain the clock produced from a signal prescribed on the optical disc 101 for synchronization with the recording reference clock, or the tracking control or the focus control may fail during recording. Information indicating such abnormalities is controlled by the drive control section 112 for controlling the drive as a whole, and if abnormalities occur during recording as described above, the drive control section 112 transmits information indicating such abnormalities to the recording completion determining section 401. The recording completion determining section 401 determines that the recording operation has not been completed normally based on the information, and outputs the determination result to the drive control section 112.

According to the focus position at the time of the determination that the recording operation has not been completed normally, the drive control section 112 controls the optical pickup 102 and the driving section 105 so that test recording is performed whereby the reproduction signal processing section 103 re-measures degrees of modulation, and determines the range of focus positions with which degrees of modulation to be used are associated for obtaining the optimum recording focus position.

Specifically, if it is determined by the recording completion determining section 401 that the recording operation has not been completed normally when the focus position is at the first focus position of −0.75 μm, among the seven focus positions of −0.75 μm, −0.5 μm, −0.25 μm, 0 μm, +0.25 μm, +0.5 μm and +0.75 μm used in test recording, the drive control section 112 instructs the laser control section 104 and the focus control section 106 so that test recording is performed while changing the focus position through seven focus positions of −0.25 μm, 0 μm, +0.25 μm, +0.5 μm, +0.75 μm, +1.0 μm and +1.25 μm. In this case, a flag is set indicating that the range of variation of the focus position has been shifted by two steps. After the range of variation of the focus position is shifted, if it is determined by the recording completion determining section 401 that the recording operation has not been completed normally when the focus position is at the fifth or subsequent one of the shifted seven focus positions, the drive control section 112 controls the laser control section 104 and the focus control section 106 to narrow the range of variation of the recording focus position so that test recording is performed while changing the focus position through seven focus positions of −0.6 μm, −0.4 μm, −0.2 μm, 0 μm, +0.2 μm, +0.4 μm and +0.6 μm. The drive control section 112 can determine whether the range of variation of the focus position has been shifted based on whether the flag is set. Moreover, if it is determined by the recording completion determining section 401 that the recording operation has been completed normally when the focus position is −0.75 μm being the first position in the original range of variation of the focus position and if it is determined by the recording completion determining section 401 that the recording operation has not been completed normally when the focus position is +0.75 μm being the seventh position in the original range of variation of the focus position, the drive control section 112 controls the laser control section 104 and the focus control section 106 so that test recording is performed while changing the focus position to −1.25 μm and to −1.0 m.

Instead of separately providing the recording completion determining section 401 and the drive control section 112 from each other, the function of the recording completion determining section 401 may be implemented by the drive control section 112.

An operation of the optical disc device of the present embodiment will now be described.

First, the optical disc device starts the recording with the recording focus position set to −0.75 μm being the first position. When the recording is discontinued when the address can no longer be obtained during recording because of a poor quality of the RF signal due to defocusing where the recording focus position is −0.75 μm, the drive control section 112 for controlling the drive as a whole sends the recording completion determining section 401 information indicating that the recording has been discontinued, and the recording completion determining section 401 determines that the recording operation has not been completed normally and outputs the determination result to the drive control section 112. Since the recording was not completed at the first step, the drive control section 112 shifts the range of variation of the recording focus position by two steps in the positive direction by instructing the laser control section 104 and the focus control section 106 so that test recording is performed while successively changing the focus position through seven steps of −0.25 μm, 0 μm, +0.25 μm, +0.5 μm, +0.75 μm, +1.0 μm and +1.25 μm.

If test recording was not discontinued while the focus position was changed through seven steps of −0.25 μm to +1.25 μm, the drive control section 112 controls the focus position determining section 402 so that degrees of modulation associated with seven focus positions of −0.25 μm, 0 m, +0.25 μm, +0.5 μm, +0.75 μm, +1.0 μm and +1.25 μm are measured so as to obtain the optimum recording focus position based on the measured degrees of modulation. Then, the drive control section 112 instructs the laser control section 104 and the focus control section 106 so that the focus position is at the optimum recording focus position during data recording.

If test recording is performed while changing the focus position starting from −0.25 μm, and the recording operation did not complete normally but failed at the fifth focus position of +0.75 μm, the sixth focus position of +1.0 μm or the seventh focus position of +1.25 μm, the drive control section 112 instructs the laser control section 104 and the focus control section 106 so that test recording is performed while successively changing the focus position through seven steps of −0.6 μm, −0.4 μm, −0.2 μm, 0 μm, +0.2 μm, +0.4 μm and +0.6 μm. Then, the drive control section 112 controls the focus position determining section 402 so that degrees of modulation associated with the seven focus positions are measured so as to obtain the optimum recording focus position based on the measured degrees of modulation.

The optical disc device may be configured so that recording is performed again with an even narrower recording range when recording is discontinued while changing the focus position through −0.6 μm, −0.4 μm, −0.2 μm, 0 μm, +0.2 μm, +0.4 μm and +0.6 μm.

If the recording operation is completed normally when the focus position is −0.75 μm being the first position, test recording is continuously performed while changing the focus position through −0.5 μm, −0.25 μm, 0 μm, +0.25 μm, +0.5 μm and +0.75 μm.

In this test recording, if the recording operation is completed normally when the focus position is −0.5 μm, −0.25 μm, 0 μm, +0.25 μm or +0.5 μm but is discontinued due to defocusing, or the like, when the focus position is +0.75 μm being the seventh position, the drive control section 112 sends the recording completion determining section 401 information indicating that recording has been discontinued, and the recording completion determining section 401 determines that the recording operation has not been completed normally and outputs the determination result to the drive control section 112. At this point, degrees of modulation for −0.75 μm, −0.5 μm, −0.25 μm, 0 μm, +0.25 μm and +0.5 μm have already been measured, and have been stored in the measurement results storing section 108 as the degrees of modulation associated with the first to fifth focus positions. In response to the output of the determination result, the drive control section 112 instructs the measurement results storing section 108 so that degrees of modulation associated with the focus positions of −0.75 μm, −0.5 μm, −0.25 μm, 0 μm and +0.25 μm are shifted and stored as those associated with the third to seventh focus positions. Since recording was not completed at the seventh step, the drive control section 112 instructs the laser control section 104 and the focus control section 106 so that test recording is performed while successively changing the focus position through two steps of −1.25 μm and −1.0 μm. Then, degrees of modulation associated with the focus positions of −1.25 μm and −1.0 μm are measured as degrees of modulation associated with the first and second focus positions, and the drive control section 112 controls the focus position determining section 402 so that the optimum recording focus position is obtained based on degrees of modulation associated with the focus positions of −1.25 μm, −1.0 μm, −0.75 μm, −0.5 μm, −0.25 μm, 0 μm and +0.25 μm. Instead of performing test recording while successively changing the focus position through two steps of −1.25 μm and −1.0 μm, test recording may be performed while successively changing the focus position through seven steps of −1.25 μm, −1.0 μm, −0.75 μm, −0.5 μm, −0.25 μm, 0 μm and +0.25 μm so as to re-measure degrees of modulation associated with the focus positions of −0.75 μm, −0.5 μm, −0.25 μm, 0 μm and +0.25 μm.

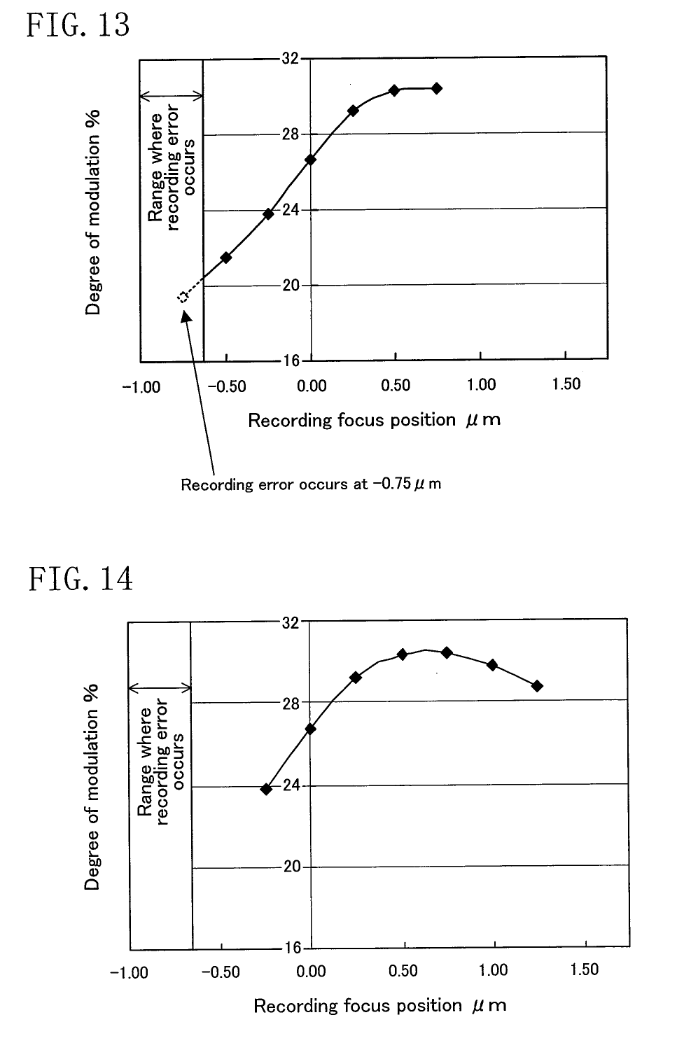

There may be a case where recording is not completed normally but fails at the focus position of −0.75 μm with the optimum recording focus position being shifted in the positive direction due to individual variations between optical pickups. For example, where the relationship between the degree of modulation and the focus position is as shown in FIG. 13, the focus position corresponding to the pole of the approximate curve as shown in FIG. 14 is obtained as the optimum recording focus position based on degrees of modulation associated with the recording focus positions in the range of −0.25 μm to +1.25 μm, instead of −0.75 μm to +0.75 μm.

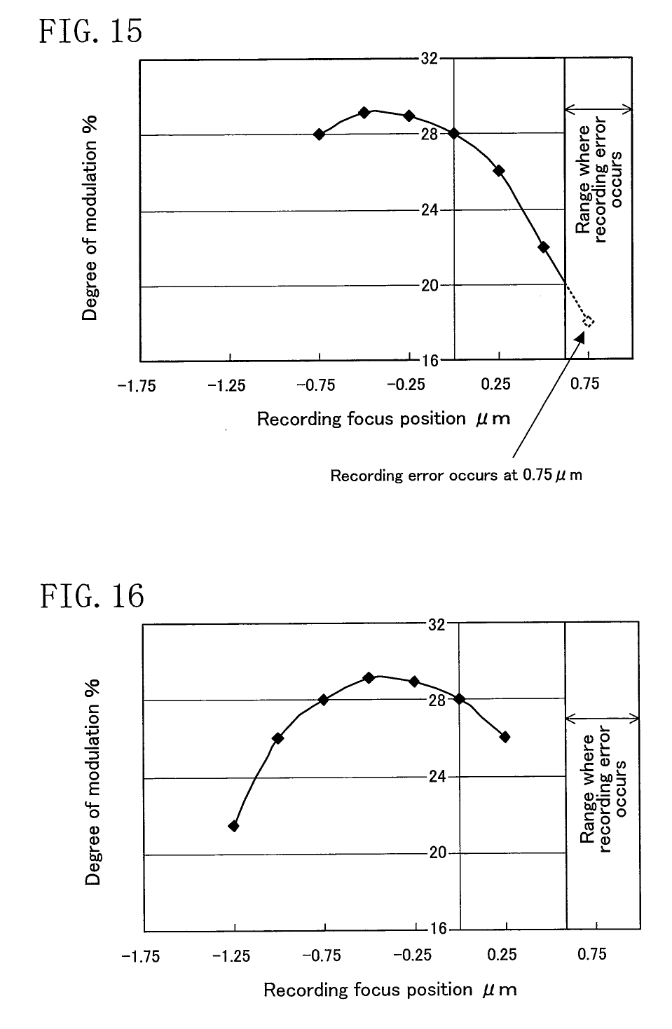

There may be a case where recording is not completed normally but fails at the focus position of +0.75 μm with the optimum recording focus position being shifted in the negative direction due to individual variations between optical pickups. For example, where the relationship between the degree of modulation and the focus position is as shown in FIG. 15, the focus position corresponding to the pole of the approximate curve as shown in FIG. 16 is obtained as the optimum recording focus position based on degrees of modulation associated with the recording focus positions in the range of −1.25 μm to +0.25 μm, instead of −0.75 μm to +0.75 μm.

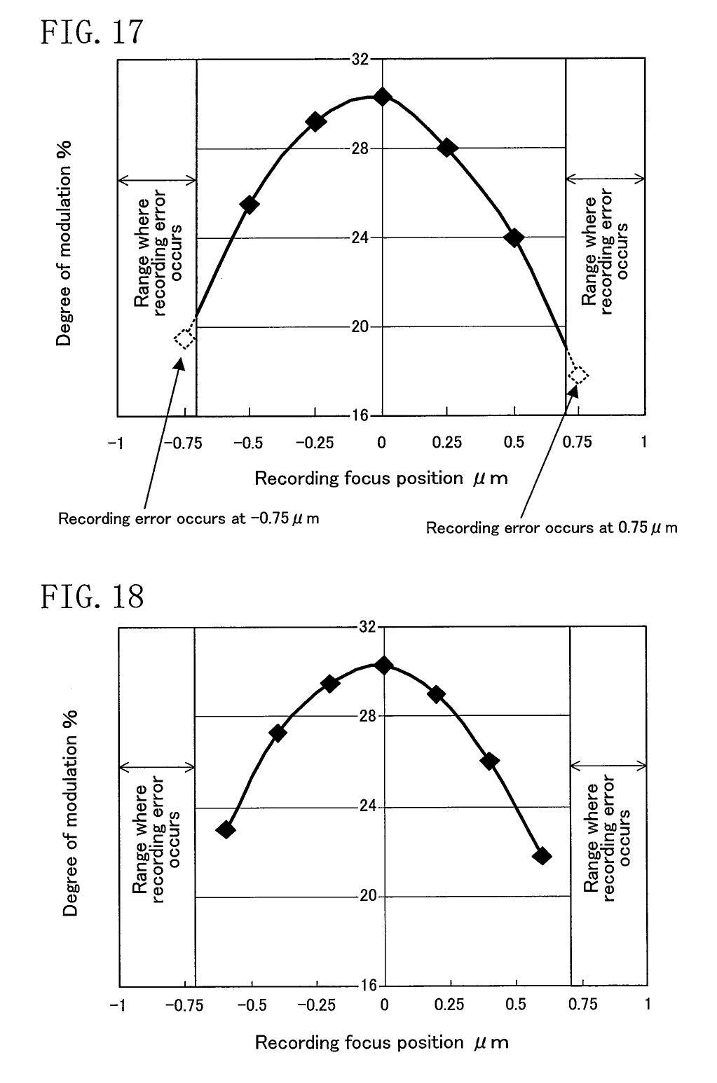

There may be a case where the range of focus positions for which recording is completed normally is narrowed due to individual variations between optical pickups. For example, where the relationship between the degree of modulation and the focus position is as shown in FIG. 17, the focus position corresponding to the pole of the approximate curve as shown in FIG. 18 is obtained as the optimum focus position based on degrees of modulation associated with the recording focus positions in the range of −0.6 μm to +0.6 μm.

In the embodiment above, the determination whether recording has been performed normally is made at the first and seventh focus positions of the original range of focus positions and at the fifth and subsequent focus positions of the shifted range of focus positions. However, the determination may be made at other steps since recording may fail at other steps, e.g., the sixth focus position of the original range of focus positions, depending on the focus position margin. Moreover, the step or steps at which it is determined whether recording is performed normally, and the number of steps by which the recording focus positions are shifted when it is determined that recording has not been performed normally, may be determined in advance based on variations in the margin of the recording focus position.

The number of steps by which the focus positions are shifted may vary depending on the step at which it is determined that recording has not been performed normally. For example, the range of variation of the focus position may be shifted by two steps if recording fails at the last step, and the range of variation of the focus position may be shifted by three steps if recording fails at the second to last step.

In the embodiment above, the range of variation of the focus position is narrowed when recording fails at the focus position or −0.75 μm and at the focus position of +0.75 μm, +1.0 μm or +1.25 μm. However, the range of variation of the focus position may be narrowed when recording fails at other steps. Moreover, the narrowed range of variation of the focus position is not limited to −0.6 μm to +0.6 μm. The step or steps at which failure of recording triggers the narrowing of the range of variation of the focus position, and the narrowed range of variation, may be determined based on variations in the margin of the optical pickup.

Thus, where test recording is performed while changing the focus position through a plurality of focus positions, if there is a focus position among the plurality of focus positions at which the recording completion determining section 401 has determined that the recording operation has not been completed normally, test recording can be performed by changing or narrowing the range of focus positions so as to exclude the focus position at which it has been determined that the recording operation has not been completed normally.

The range of variation of the focus position, the amount by which the range of variation of the focus position is shifted or narrowed depending on determination, and the number of steps through which the focus position is changed, are derived in advance by experiments, etc. For example, the range of variation of the focus position, the amount by which the range of variation of the focus position is shifted or narrowed depending on determination, and the number of steps through which the focus position is changed, may be derived based on measurement results that are obtained by measuring, in experiments, the margin of the recording focus position for which recording is completed normally or the variations in the optimum recording focus position by using various optical pickups. The way of deriving is not limited to experiments, but may be simulation, etc.

Based on at which focus position it has been determined that recording has not been completed normally, the optical disc device of the embodiment above shifts or narrows the original range of focus positions used for obtaining the optimum recording focus position so as to exclude the focus position at which it has been determined that recording has not been completed normally. Therefore, it is possible to properly obtain the optimum recording focus position even if the optimum recording focus position is shifted or if there is only a narrow margin of focus position at which recording can be performed normally.

### Alternative Embodiments

The optical disc device of the embodiment above measures degrees of modulation and obtains an approximate equation representing the relationship between the degree of modulation and the focus position. Alternatively, any of the β value, the asymmetry value, the RF amplitude value, the jitter value, etc., may be measured, instead of the degrees of modulation, so as to obtain an approximate equation representing the relationship between the measurement result and the focus position. Other than these values, any other value that indicates the recording quality of the signal recorded on the optical disc, i.e., the state of the RF signal, may be used.

The optical disc device of the embodiment above performs test recording while changing the focus position through seven positions. Alternatively, test recording may be performed while changing the focus position through a number of positions other than seven.

### INDUSTRIAL APPLICABILITY

As described above, the optical disc signal processing device, the integrated circuit, the optical disc device and the optimum recording focus position detecting method of the present invention have an advantage that the optimum recording focus position can be obtained properly, and are useful, for example, as a technique for adjusting the optimum recording focus position, or the like.

1-17. (canceled)

18. An optical disc signal processing device for controlling recording/reproduction of an optical disc, comprising:
a drive control section for controlling an optical pickup; and
a focus position determining section, wherein when test recording is performed while changing a focus position through a plurality of positions, the focus position determining section obtains an optimum recording focus position based on recording qualities of regions on the optical disc where the test recording has been performed,
wherein the focus position determining section includes:
a recording state measuring section for measuring, for each focus position, a recording quality of a region on the optical disc where the test recording has been performed; and
a determination section for determining, according to a predetermined criterion, whether laser power during the test recording is suitable for obtaining the optimum recording focus position, based on the recording quality obtained for each focus position by the recording state measuring section, wherein:
when it is determined by the determination section that the laser power during the test recording is not suitable for obtaining the optimum recording focus position, the drive control section controls the optical pickup so that the test recording is performed again with the laser power changed;
the predetermined criterion is that a difference between a maximum value and a minimum value of the recording quality obtained for each focus position by the recording state measuring section is less than or equal to a first predetermined value and at least one of the recording quality is greater than or equal to a second predetermined value;
the determination section determines that the laser power during the test recording is not suitable for obtaining the optimum recording focus position if the recording quality obtained for each focus position by the recording state measuring section meets the predetermined criterion; and
when it is determined by the determination section that the laser power during the test recording is not suitable for obtaining the optimum recording focus position, the drive control section controls the optical pickup so that the test recording is performed again with the laser power lowered.

19. An optical disc signal processing device for controlling recording/reproduction of an optical disc, comprising:
a drive control section for controlling an optical pickup; and
a focus position determining section, wherein when test recording is performed while changing a focus position through a plurality of positions, the focus position determining section obtains an optimum recording focus position based on recording qualities of regions on the optical disc where the test recording has been performed,
wherein the focus position determining section includes:
a recording state measuring section for measuring, for each focus position, a recording quality of a region on the optical disc where the test recording has been performed; and
a determination section for determining, according to a predetermined criterion, whether laser power during the test recording is suitable for obtaining the optimum recording focus position, based on the recording quality obtained for each focus position by the recording state measuring section, wherein:
when it is determined by the determination section that the laser power during the test recording is not suitable for obtaining the optimum recording focus position, the drive control section controls the optical pickup so that the test recording is performed again with the laser power changed;
the predetermined criterion is that a difference between a maximum value and a minimum value of the recording quality is less than or equal to a first predetermined value and at least one of the recording quality is less than or equal to a second predetermined value;
the determination section determines that the laser power during the test recording is not suitable for obtaining the optimum recording focus position if the recording quality obtained for each focus position by the recording state measuring section meets the predetermined criterion; and
when it is determined by the determination section that the laser power during the test recording is not suitable for obtaining the optimum recording focus position, the drive control section controls the optical pickup so that the test recording is performed again with the laser power raised.

20. An optical disc signal processing device for controlling recording/reproduction of an optical disc, comprising:
a drive control section for controlling an optical pickup; and
a focus position determining section, wherein when test recording is performed while changing a focus position through a plurality of positions, the focus position determining section obtains an optimum recording focus position based on recording qualities of regions on the optical disc where the test recording has been performed,
wherein the focus position determining section includes:
a recording state measuring section for measuring, for each focus position, a recording quality of a region on the optical disc where the test recording has been performed; and
a determination section for determining, according to a predetermined criterion, whether laser power during the test recording is suitable for obtaining the optimum recording focus position, based on the recording quality obtained for each focus position by the recording state measuring section, wherein:
when it is determined by the determination section that the laser power during the test recording is not suitable for obtaining the optimum recording focus position, the drive control section controls the optical pickup so that the test recording is performed again with the laser power changed;
the predetermined criterion is that at least one of the recording quality is greater than or equal to a predetermined value;
the determination section determines that the laser power during the test recording is not suitable for obtaining the optimum recording focus position if the recording quality obtained for each focus position by the recording state measuring section meets the predetermined criterion; and
when it is determined by the determination section that the laser power during the test recording is not suitable for obtaining the optimum recording focus position, the drive control section controls the optical pickup so that the test recording is performed again with the laser power lowered.

21. An optical disc signal processing device for controlling recording/reproduction of an optical disc, comprising:
a drive control section for controlling an optical pickup; and
a focus position determining section, wherein when test recording is performed while changing a focus position through a plurality of positions, the focus position determining section obtains an optimum recording focus position based on recording qualities of regions on the optical disc where the test recording has been performed,
wherein the focus position determining section includes:
a recording state measuring section for measuring, for each focus position, a recording quality of a region on the optical disc where the test recording has been performed; and
a determination section for determining, according to a predetermined criterion, whether laser power during the test recording is suitable for obtaining the optimum recording focus position, based on the recording quality obtained for each focus position by the recording state measuring section, wherein:
when it is determined by the determination section that the laser power during the test recording is not suitable for obtaining the optimum recording focus position, the drive control section controls the optical pickup so that the test recording is performed again with the laser power changed;
the predetermined criterion is that at least one of the recording quality is less than or equal to a predetermined value;
the determination section determines that the laser power during the test recording is not suitable for obtaining the optimum recording focus position if the recording quality obtained for each focus position by the recording state measuring section meets the predetermined criterion; and
when it is determined by the determination section that the laser power during the test recording is not suitable for obtaining the optimum recording focus position, the drive control section controls the optical pickup so that the test recording is performed again with the laser power raised.

22. An optical disc signal processing device for controlling recording/reproduction of an optical disc, comprising:
a drive control section for controlling an optical pickup; and
a focus position determining section, wherein when test recording is performed while changing a focus position through a plurality of positions, the focus position determining section obtains an optimum recording focus position based on recording qualities of regions on the optical disc where the test recording has been performed,
wherein the focus position determining section includes:
a recording state measuring section for measuring, for each focus position, a recording quality of a region on the optical disc where the test recording has been performed; and
a determination section for determining, according to a predetermined criterion, whether laser power during the test recording is suitable for obtaining the optimum recording focus position, based on the recording quality obtained for each focus position by the recording state measuring section, wherein:
when it is determined by the determination section that the laser power during the test recording is not suitable for obtaining the optimum recording focus position, the drive control section controls the optical pickup so that the test recording is performed again with the laser power changed;
the predetermined criterion is that a coefficient a in an equation Y=a*X*X+b*X+c is greater than or equal to a first predetermined value and a coefficient c therein is greater than or equal to a second predetermined value, wherein the equation represents an approximate function obtained based on the recording quality for each focus position, where X is the focus position and Y is a recording state;
the determination section determines that the laser power during the test recording is not suitable for obtaining the optimum recording focus position if the recording quality obtained for each focus position by the recording state measuring section meets the predetermined criterion; and
when it is determined by the determination section that the laser power during the test recording is not suitable for obtaining the optimum recording focus position, the drive control section controls the optical pickup so that the test recording is performed again with the laser power lowered.

23. An optical disc signal processing device for controlling recording/reproduction of an optical disc, comprising:
a drive control section for controlling an optical pickup; and
a focus position determining section, wherein when test recording is performed while changing a focus position through a plurality of positions, the focus position determining section obtains an optimum recording focus position based on recording qualities of regions on the optical disc where the test recording has been performed,
wherein the focus position determining section includes:
a recording state measuring section for measuring, for each focus position, a recording quality of a region on the optical disc where the test recording has been performed; and
a determination section for determining, according to a predetermined criterion, whether laser power during the test recording is suitable for obtaining the optimum recording focus position, based on the recording quality obtained for each focus position by the recording state measuring section, wherein:
when it is determined by the determination section that the laser power during the test recording is not suitable for obtaining the optimum recording focus position, the drive control section controls the optical pickup so that the test recording is performed again with the laser power changed;
the predetermined criterion is that a coefficient a in an equation Y=a*X*X+b*X+c is greater than or equal to a first predetermined value and a coefficient c therein is less than a second predetermined value, wherein the equation represents an approximate function obtained based on the recording quality for each focus position, where X is the focus position and Y is a recording state;
the determination section determines that the laser power during the test recording is not suitable for obtaining the optimum recording focus position if the recording quality obtained for each focus position by the recording state measuring section meets the predetermined criterion; and
when it is determined by the determination section that the laser power during the test recording is not suitable for obtaining the optimum recording focus position, the drive control section controls the optical pickup so that the test recording is performed again with the laser power raised.

24. An integrated circuit for controlling recording/reproduction of an optical disc, comprising:
a drive control section for controlling an optical pickup; and
a focus position determining section, wherein when test recording is performed while changing a focus position through a plurality of positions, the focus position determining section obtains an optimum recording focus position based on recording qualities of regions on the optical disc where the test recording has been performed,
wherein the focus position determining section includes:
a recording state measuring section for measuring, for each focus position, a recording quality of a region on the optical disc where the test recording has been performed; and
a determination section for determining, according to a predetermined criterion, whether laser power during the test recording is suitable for obtaining the optimum recording focus position, based on the recording quality obtained for each focus position by the recording state measuring section, wherein:
when it is determined by the determination section that the laser power during the test recording is not suitable for obtaining the optimum recording focus position, the drive control section controls the optical pickup so that the test recording is performed again with the laser power changed;
the predetermined criterion is that a difference between a maximum value and a minimum value of the recording quality obtained for each focus position by the recording state measuring section is less than or equal to a first predetermined value and at least one of the recording quality is greater than or equal to a second predetermined value;
the determination section determines that the laser power during the test recording is not suitable for obtaining the optimum recording focus position if the recording quality obtained for each focus position by the recording state measuring section meets the predetermined criterion; and
when it is determined by the determination section that the laser power during the test recording is not suitable for obtaining the optimum recording focus position, the drive control section controls the optical pickup so that the test recording is performed again with the laser power lowered.

25. An optical disc device, comprising:
the integrated circuit of claim 24;
the optical pickup; and
a driving section for driving the optical pickup.

26. An optimum recording focus position detecting method for an optical disc device for recording/reproducing an optical disc, wherein test recording is performed while changing a focus position through a plurality of positions, and the optimum recording focus position is obtained based on recording qualities of regions on the optical disc where the test recording has been performed, the method comprising:
a first step of performing test recording while changing a focus position through a plurality of positions;
a second step of measuring, for each focus position, a recording quality of a region on the optical disc where the test recording has been performed;
a third step of determining, according to a predetermined criterion, whether laser power during the test recording is suitable for obtaining the optimum recording focus position, based on the recording quality obtained for each focus position in the second step; and
a fourth step of, if it is determined in the third step that the laser power during the test recording is not suitable for obtaining the optimum recording focus position, performing the test recording again with the laser power changed, wherein:
the predetermined criterion is that a difference between a maximum value and a minimum value of the recording quality obtained for each focus position in the second step is less than or equal to a first predetermined value and at least one of the recording quality is greater than or equal to a second predetermined value;
it is determined in the third step that the laser power during the test recording is not suitable for obtaining the optimum recording focus position if the recording quality obtained for each focus position in the second step meets the predetermined criterion; and
when it is determined in the third step that the laser power during the test recording is not suitable for obtaining the optimum recording focus position, the test recording is performed again in the fourth step with the laser power lowered.

27. An optical disc signal processing device for controlling recording/reproduction of an optical disc, comprising:
a drive control section for controlling an optical pickup;
a focus position determining section, wherein when test recording is performed while changing a focus position through a plurality of positions, the focus position determining section obtains an optimum recording focus position based on recording qualities of regions on the optical disc where the test recording has been performed; and
a recording completion determining section for determining whether a recording operation has been completed normally for each focus position in the test recording,
wherein if there is a focus position among the plurality of focus positions at which it has been determined by the recording completion determining section that the recording operation has not been completed normally, the drive control section controls the optical pickup so that the test recording is performed again with a range of focus positions changed so as to exclude the focus position at which it has been determined by the recording completion determining section that the recording operation has not been completed normally.

28. The optical disc signal processing device of claim 27, wherein if it is determined by the recording completion determining section that the recording operation has not been completed normally at a lower limit position of a range of the plurality of focus positions, the drive control section controls the optical pickup so that the test recording is performed again with the range of focus positions shifted toward an upper limit so as to exclude the lower limit position.

29. The optical disc signal processing device of claim 27, wherein if it is determined by the recording completion determining section that the recording operation has not been completed normally at an upper limit position of a range of the plurality of focus positions, the drive control section controls the optical pickup so that the test recording is performed again with the range of focus positions shifted toward a lower limit so as to exclude the upper limit position.

30. The optical disc signal processing device of claim 27, wherein if it is determined by the recording completion determining section that the recording operation has not been completed normally at a lower limit position and an upper limit position of a range of the plurality of focus positions, the drive control section controls the optical pickup so that the test recording is performed with the range of focus positions narrowed so as to exclude the lower limit position and the upper limit position.

31. An integrated circuit for controlling recording/reproduction of an optical disc, comprising:
a drive control section for controlling an optical pickup;
a focus position determining section, wherein when test recording is performed while changing a focus position through a plurality of positions, the focus position determining section obtains an optimum recording focus position based on recording qualities of regions on the optical disc where the test recording has been performed; and
a recording completion determining section for determining whether a recording operation has been completed normally for each focus position in the test recording,
wherein if there is a focus position among the plurality of focus positions at which it has been determined by the recording completion determining section that the recording operation has not been completed normally, the drive control section controls the optical pickup so that the test recording is performed again with a range of focus positions changed so as to exclude the focus position at which it has been determined by the recording completion determining section that the recording operation has not been completed normally.

32. An optical disc device, comprising:
an integrated circuit of claim 31;
the optical pickup; and
a driving section for driving the optical pickup.

33. An optimum recording focus position detecting method for an optical disc device for recording/reproducing an optical disc, wherein test recording is performed while changing a focus position through a plurality of positions, and the optimum recording focus position is obtained based on recording qualities of regions on the optical disc where the test recording has been performed, the method comprising:
a first step of performing test recording while changing a focus position through a plurality of positions;
a second step of determining whether a recording operation has been completed normally for each focus position in the test recording; and
a third step of, if there is a focus position among the plurality of focus positions at which it has been determined in the second step that the recording operation has not been completed normally, performing the test recording with a range of focus positions changed so as to exclude the focus position at which it has been determined in the second step that the recording operation has not been completed normally.
